(19) United States
(12) Patent Application Publication
(10) Pub. No.: US 2011/0087483 A1
(43) Pub. Date: Apr. 14, 2011

(54) EMOTION ANALYZING METHOD, EMOTION ANALYZING SYSTEM, COMPUTER READABLE AND WRITABLE RECORDING MEDIUM AND EMOTION ANALYZING DEVICE

(75) Inventors: Chang-Tai Hsieh, Taipei County (TW); Von-Wun Soo, Hsinchu City (TW); Chao-Chun Kao, Taipei City (TW); Ting-Hao Yang, Taipei City (TW); Chun-Chieh Liu, Pingtung County (TW); Shih-Chun Chou, Taipei City (TW)

(73) Assignee: INSTITUTE FOR INFORMATION INDUSTRY, Taipei (TW)

(21) Appl. No.: 12/626,945

(22) Filed: Nov. 30, 2009

(30) Foreign Application Priority Data
Oct. 9, 2009 (TW) 98134315

(51) Int. Cl. G06F 17/27

(52) U.S. Cl. 704/9

(57) ABSTRACT

A system for analyzing a sentence emotion is provided. The system comprises a case repository, an input module, a sentence structure analyzing module, a similarity analyzing module and an emotion detection module. The case repository stores several case sentences and each case sentence comprises at least one major term and is corresponding to at least one emotion annotation. The input module receives an input sentence and the sentence structure analyzing module analyzes a sentence structure of the input sentence. The similarity analyzing module performs a semantic analysis and a syntax analysis according to the sentence structure to obtain a similarity level between the input sentence and each of the case sentences. The emotion detection module detects at least one emotion of the input sentence according to the similarity level between the input sentence and each of the case sentences.

### CROSS-REFERENCE TO RELATED APPLICATION

This application claims the priority benefit of Taiwan application serial no. 98134315, filed Oct. 9, 2009. The entirety of the above-mentioned patent application is hereby incorporated by reference herein and made a part of specification.

### BACKGROUND OF THE INVENTION

1. Field of the Invention

The present invention relates to an emotion analyzing method and an emotion analyzing system, and particular relates to a sentence emotion analyzing method, sentence emotion analyzing system, a computer readable and writable recording medium for storing a sentence emotion analyzing program and an emotion analyzing device for executing the sentence emotion analyzing program.

2. Description of Related Art

Currently, because of the rapid advancement of the electronic technology, people cannot be satisfied with the communication modes between the user and the smart-type electronic device, in which the user inputs a command into the electronic device and the electronic device response the user in form of characters. Therefore, the future communication interfaces between humans and smart-type electronic devices are developed to be controlled by the most natural and convenient communication medium “speech”. Thus, in order to increase the diversity and the humanity of the communication interface, many experts and manufacturers have been developing the emotion recognition technology.

However, the currently developed sentence emotion recognition systems focus on recognizing the emotion-related words or keywords to carry out the emotion recognition of the sentence. If the sentence to be recognized does not include any emotion-related words or keywords, it cannot be recognized. Furthermore, the general emotion recognition system lacks the information about semantic and syntax structure so that it is hard to deduce the emotion implied in the sentence or the multiple emotions in the sentence from the semantic and the syntax of the sentence to be recognized. Conventionally, the classification technique of the support vector machine (SVM) are usually applied to classify the sentence emotions. However, when a new case sentence appears, it is necessary to re-train the emotion classification model and lots of time will be wasted.

### SUMMARY OF THE INVENTION

The invention provides an emotion analyzing system, an emotion analyzing device, a method for analyzing emotion and a computer readable and writable recording medium, which are adopted to a sentence. By building-up a case emotion ontology, the semantic emotion of an input sentence can be accurately detected.

The invention provides an emotion analyzing system, an emotion analyzing device, a method for analyzing emotion and a computer readable and writable recording medium which are capable of detecting the explicit emotion or the implied emotion of the input sentence according to the results of the semantic analysis and the syntax analysis of the input sentence.

The invention provides an emotion analyzing system, an emotion analyzing device, a method for analyzing emotion and a computer readable and writable recording medium which are capable of detecting the multiple emotions of the input sentence.

The invention provides an emotion analyzing system, an emotion analyzing device, a method for analyzing emotion and a computer readable and writable recording medium which are capable of detecting the semantic emotion of the input sentence by analyzing the similarities between the input sentence and case sentences in a sample database.

The present invention provides an emotion analyzing system comprising a case repository, an input module, a sentence analyzing module, a similarity analyzing module and an emotion detection module. The case repository includes a plurality of case sentences, and each of the case sentences includes at least a major term and each of the case sentences corresponds to at least an emotion annotation. The input module is used for receiving an input sentence. The sentence analyzing module is used to analyze a sentence structure of the input sentence. The similarity analyzing module is used to perform a semantic analysis and a syntax analysis on the input sentence and on at least a case sentence in the case repository, according to the sentence structure, so as to obtain a similarity level between the input sentence and the at least case sentence. The emotion detection module is used to detect at least an emotion of the input sentence according to the similarity level between the input sentence and the at least case sentence.

The invention further provides an emotion analyzing device comprising a housing, an input unit, a storage unit, a processor and a display unit. The input unit is configured at the exterior of the housing for receiving an input sentence. The storage unit configured in the interior of the housing is used for storing a case repository, wherein the case repository includes a plurality of case sentences, and each of the case sentences includes at least a major term and each of the case sentences corresponds to at least an emotion annotation. The processor configured in the interior of the housing is connected to the input unit and the storage unit and the processor is used for analyzing a sentence structure of the input sentence, and performing a semantic analysis and a syntax analysis on the input sentence and on at least a case sentence in the case repository, according to the sentence structure, so as to obtain a similarity level between the input sentence and the at least case sentence, and detecting at least an emotion of the input sentence. The display unit is used for displaying an emotion feedback corresponding to the detected emotion.

The invention also provides an emotion analyzing method implemented with a case repository, wherein the case repository includes a plurality of case sentences, and each of the case sentences includes at least a major term and each of the case sentences corresponds to at least an emotion annotation. The emotion analyzing method comprises receiving an input sentence. A sentence structure of the input sentence is analyzed. A similarity analyzing process is performed to simultaneously implement a semantic analysis and a syntax analysis on the input sentence and on at least a case sentence in the case repository, according to the sentence structure, so as to obtain a similarity level between the input sentence and the at least case sentence. According to the similarity level between the input sentence and the at least case sentence, at least an emotion of the input sentence is detected.

The invention also provides computer readable and writable recording medium for storing an emotion analyzing program and a case repository, wherein the case repository includes a plurality of case sentences, and each of the case sentences includes at least a major term and each of the case sentences corresponds to at least an emotion annotation. The emotion analyzing program executes a plurality of commands. The commands comprise receiving an input sentence. A sentence structure of the input sentence is analyzed. A similarity analyzing process is performed to simultaneously implement a semantic analysis and a syntax analysis on the input sentence and on at least a case sentence in the case repository, according to the sentence structure, so as to obtain a similarity level between the input sentence and the at least case sentence. According to the similarity level between the input sentence and the at least case sentence, at least an emotion of the input sentence is detected.

In the emotion analyzing system, the emotion analyzing device, the emotion analyzing method and the computer readable and writable medium of the present invention, the analysis of the sentence structure of the input sentence is to analyze a plurality of input terms of the input sentence and to annotate each of the input terms a lexical category, and, according to the lexical category each of the input terms belongs to, at least a keyword in the input sentence is determined.

In the emotion analyzing system, the emotion analyzing device, the emotion analyzing method and the computer readable and writable medium of the present invention, there is an emotion ontology, and the emotion ontology comprises a plurality of ontology components. Furthermore, the analysis of the sentence structure of the input sentence is to analyze a plurality of input terms in the input sentence and, according to the input terms and the ontology components of the emotion ontology, at least a keyword in the input sentence is determined. In another embodiment, in the emotion analyzing system, the emotion analyzing device, the emotion analyzing method and the computer readable and writable medium, there are a synonym data and an antonym data for being adopted with the input teens of the input sentence and the ontology components of the emotion ontology in determining at least a keyword in the input sentence after the input terms of the input sentence are analyzed. In the other embodiment, in the emotion analyzing system, the emotion analyzing device, the emotion analyzing method and the computer readable and writable medium, at least a keyword of the input sentence is determined; the syntax analysis is used to analyze the sentence structure similarity level between the input sentence and at least a case sentence, and the semantic analysis, according to the emotion ontology, is used to analyze a semantic level between each of the keywords in the input sentence and the major terms of the at least a case sentence; and, according to the sentence structure similarity level and the semantic level, the similarity level between the input sentence and the at least a case sentence.

In the emotion analyzing system, the emotion analyzing device, the emotion analyzing method and the computer readable and writable medium of the present invention, the syntax analysis is to compare a parse tree of the input sentence with a structure of the at least a case sentence, and, according to the number of the editorial steps for re-editing the input sentence to be the at least a case sentence, the sentence structure similarity level is determined.

In the emotion analyzing system, the emotion analyzing device, the emotion analyzing method and the computer readable and writable medium of the present invention, the semantic level is determined by calculating a hierarchical distance between the ontology components corresponding to the keywords in the input sentence and the ontology components corresponding to the major terms of the case sentence, and the aforementioned major terms are with respect to the keywords in the input sentence respectively.

In the emotion analyzing system, the emotion analyzing device, the emotion analyzing method and the computer readable and writable medium of the present invention, an emotion feedback with respect to the emotion of the input sentence, is outputted.

In the emotion analyzing system, the emotion analyzing device, the emotion analyzing method and the computer readable and writable medium of the present invention, the emotion feedback includes an emotion symbol, an emotional expression image, a text, an audio effect, a light effect or a mechanical operation.

Accordingly, in the present invention, by using the case sentences in the case repository and the emotion ontology, the syntax analysis and the semantic analysis are performed on the input sentence so as to obtain the similarity level between the input sentence and each of the case sentences. According to the similarity level, the sentence emotion of the input sentence can be detected. By using the concept-relation-instance feature of the emotion ontology, the accuracy of deducing the sentence emotion of single input sentence is increased, and the various emotions of various input sentences can also be detected, and not only the explicit emotion in the sentence can be detected but also the implied emotion in the sentence can be detected.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an emotion analyzing system according to one embodiment of the invention.

FIG. 2 is a flow chart showing an emotion analyzing method according to one embodiment of the invention.

FIG. 3 is a schematic view of an emotion ontology according to one embodiment of the present invention.

FIG. 4 is a schematic view showing the step of analyzing a sentence structure of an input sentence according to one embodiment of the present invention.

FIG. 5 is a schematic view showing the step of analyzing a similarity level between the input sentence and the case sentences according to one embodiment of the present invention.

FIG. 6 is a schematic view showing the step of analyzing a semantic level between the input sentence and the case sentences according to one embodiment of the present invention.

FIG. 7 is a schematic view of an emotion analyzing device according to one embodiment of the invention.

FIG. 8 is a schematic view of a pet game console according to one embodiment of the invention.

### DESCRIPTION OF EMBODIMENTS

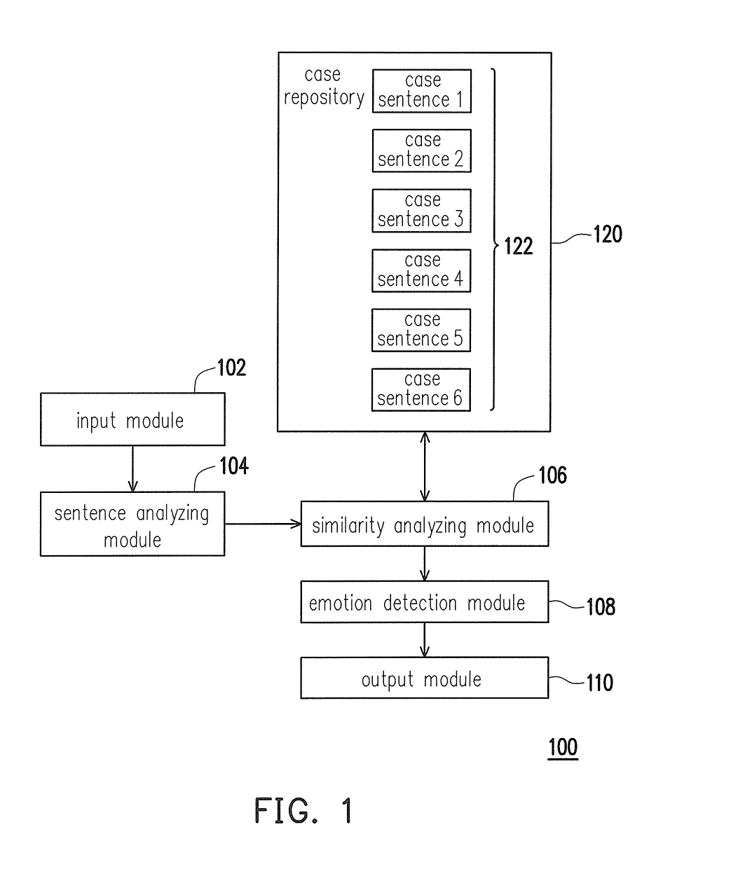

FIG. 1 is a schematic view of an emotion analyzing system according to one embodiment of the invention. As shown in FIG. 1, an emotion analyzing system 100 of the present invention comprises an input module 102, a sentence analyzing module 104, a similarity analyzing module 106, an emotion detection module 108 and an output module 110. It should be noticed that the meaning of the term “emotion detection” is as same as the meaning of the term “emotion recognition” and the terminology used herein is not limited the scope of the present invention.

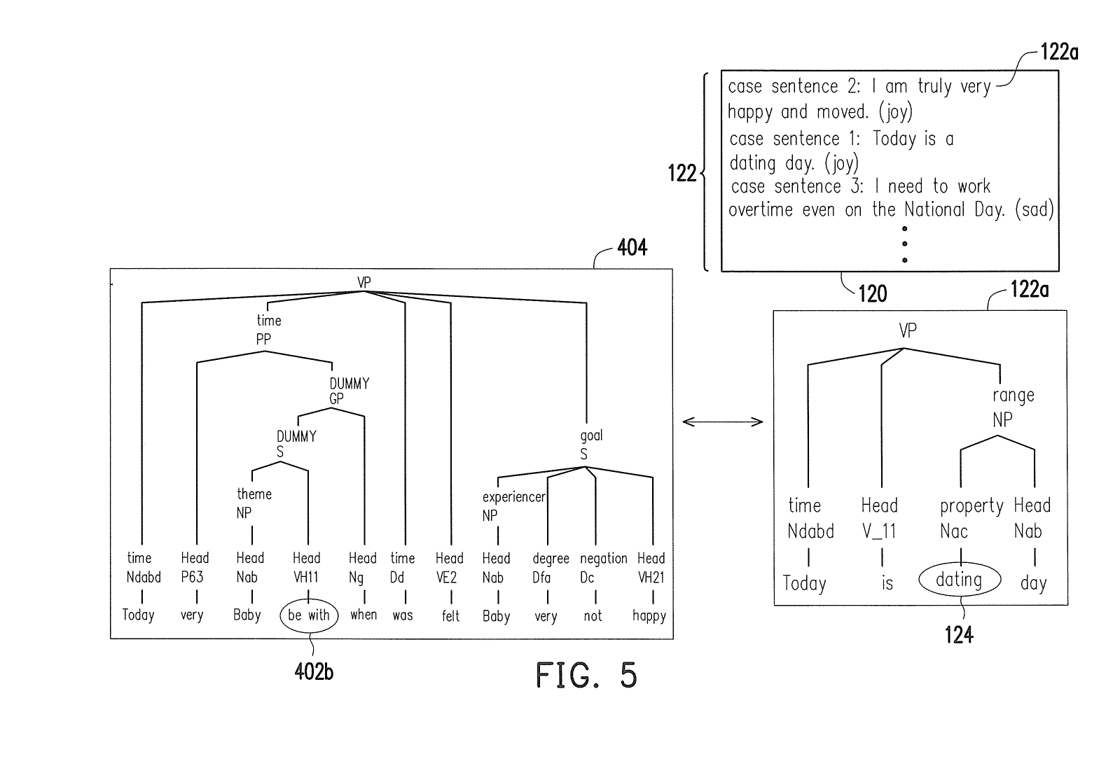

Moreover, the emotion analyzing system 100 of the present invention further comprises a case repository 120. The case repository 120 includes a plurality of case sentences 122, and each of the case sentences 122 includes at least a major term and each of the case sentences corresponds to at least an emotion annotation. It should be noticed that the word “term” in the present invention literally represents vocabulary, word or phrase. In the embodiment shown in FIG. 5, the case repository 120 comprises a plurality of case sentences 122, such as the case sentence 1, the case sentence 2, the case sentence 3, etc., and each of the case sentences 122 has at least one major term and each of the case sentences 122 corresponds to at least one emotion annotation, such as the quoted emotion annotation following each of the case sentences in FIG. 5. Taking the case sentence 1 as an example, the case sentence 1 shows “Today is a dating day.”, and the term “date” is the major term in the case sentence 1, and the quoted term “joy” is the emotion annotation to which the case sentence 1 corresponds. The emotion annotation of each of the case sentences 122 can be classified into several emotion classes by using the general emotion classification method. The number of the emotion classes is, for example, about 22. Alternatively, the emotion annotation of each of the case sentences 122 can be classified according to the user-defining emotion classification or the program developer-defining emotion classification.

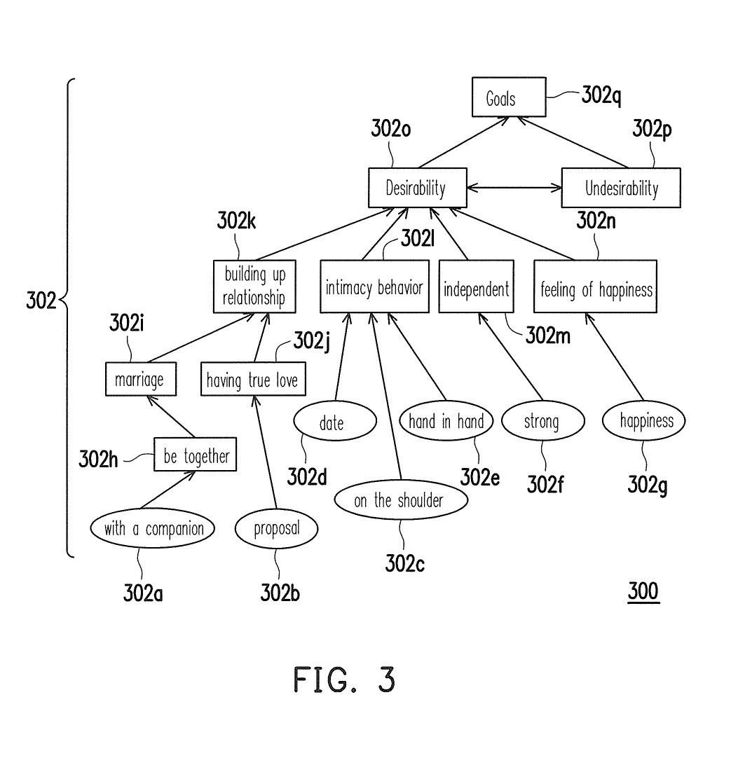

Moreover, the emotion analyzing system 100 of the present invention further comprises an emotion ontology. FIG. 3 is a schematic view of an emotion ontology according to one embodiment of the present invention. As shown in FIG. 3, an emotion ontology 300 comprises a plurality of ontology components 302, such as ontology components 302a through 302q. In one embodiment, the emotion ontology 300 can be a known emotion ontology composed of the concepts of terms, relations between different concepts and a plurality of instances. In another embodiment, the concepts of the major terms of the case sentences 122 in the case repository 120 and the concept relations between different concepts are analyzed and then the concepts of the major terms, the concept relations and the instances of the case sentences 122 together construct the emotion ontology 300. In the other embodiment, the aforementioned emotion ontology 300 can be built up according to the Ortony-Clore-Collins (OCC) emotion model and a basis of instances triggering emotions. Moreover, the emotion ontology can be expanded by adding new terms therein. Alternatively, the ontology can be flexibly expanded by adding synonyms or antonyms corresponding to the terms.

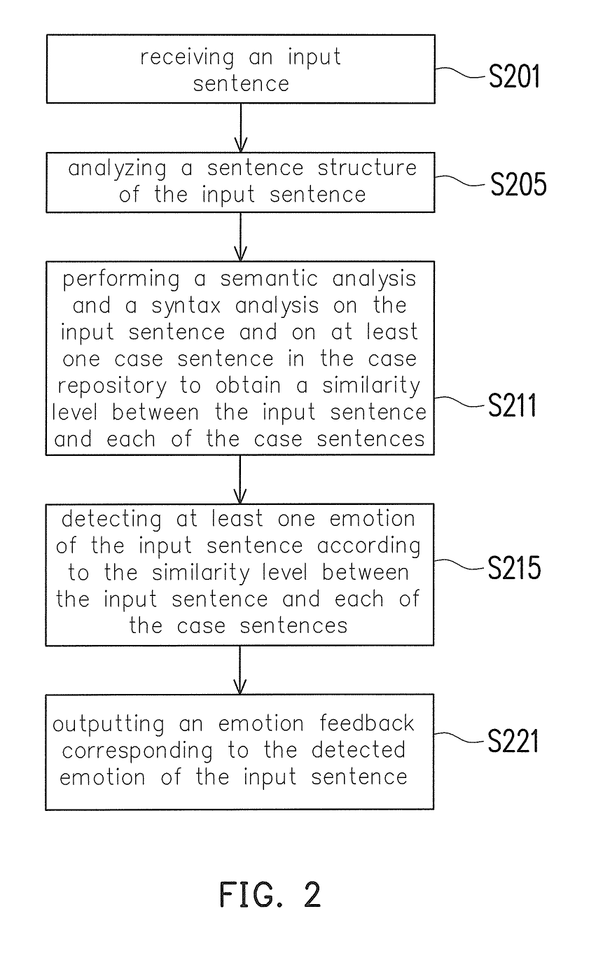

FIG. 2 is a flow chart showing an emotion analyzing method according to one embodiment of the invention. As shown in FIG. 1 and FIG. 2, in the step S201, the input module 102 receives an input sentence. The input module 102 receives the input sentence inputted through a user interface such as a human-machine interaction interface, a signal transmission interface, a micro-blog interface or a text editor. Then, in the step S205, the sentence analyzing module 104 analyzes a sentence structure of the input sentence.

Then, in the step S211, the similarity analyzing module 106 performs a semantic analysis and a syntax analysis on the input sentence and on at least one case sentence in the case repository 120, according to the sentence structure. Therefore, a similarity level between the input sentence and each of the case sentences 122 is obtained. In the step S215, the emotion detection module 108 detects at least one emotion of the input sentence according to the similarity level between the input sentence and each of the case sentences 122.

Furthermore, in one embodiment, after the step S215, the emotion analyzing method of the present invention further comprises outputting an emotion feedback corresponding to the detected emotion of the input sentence by the output module 110 (the step S221). The emotion feedback can be, for example, an emotion symbol, an emotional expression image, a text, an audio effect, a light effect or a mechanical operation. Furthermore, the output module 110, for example, can be connected to, for example, a display, an audio output device, a light displaying device, an LED display, an electronic pet, etc. for practically showing the aforementioned emotion feedbacks.

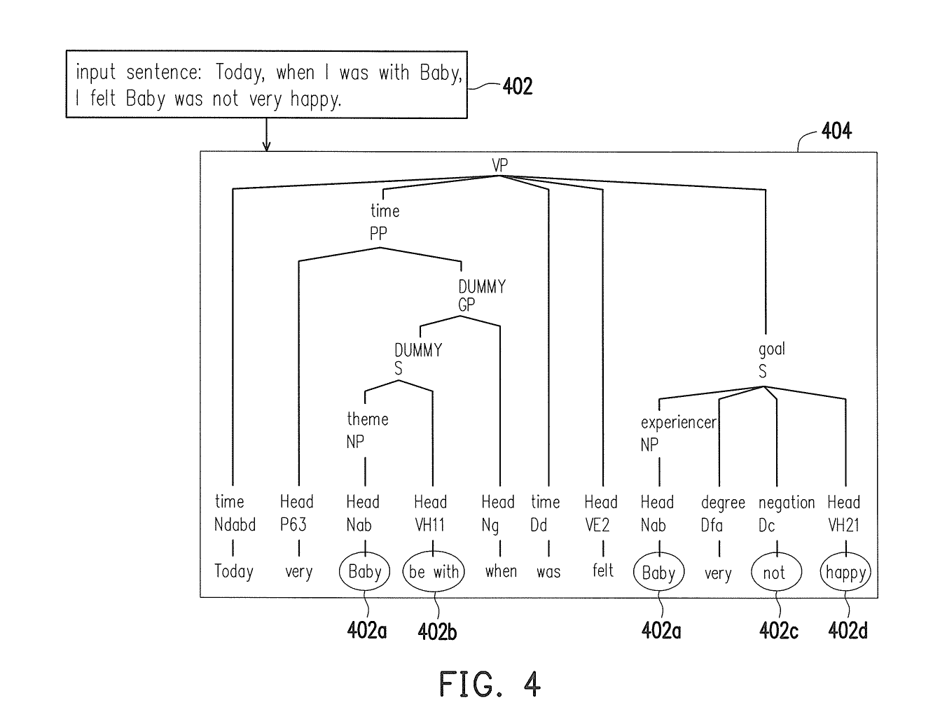

In addition, FIG. 4 is a schematic view showing the step of analyzing a sentence structure of an input sentence according to one embodiment of the present invention. As shown in FIG. 4, when the user inputs a sentence 402 which shows “Today, when I was with Baby, I felt Baby was not very happy.”, the sentence analyzing module 104 analyzes the sentence structure of the input sentence 402. That is, sentence analyzing module 104 analyzes a plurality of input terms of the input sentence 402 and annotates each of the input terms a lexical category, and, according to the lexical category each of the input terms belongs to, at least one keyword in the input sentence 402 is determined. As shown in FIG. 4, by using the parse tree method, the input sentence is divided into several input terms. A parse tree 404 of the input sentence 402 is generated according to a lexical category analysis and the concept of each input terms and then at least one keyword of the input sentence is determined. For instance, the keywords of the input sentence 402 include “Baby” (labeled as keyword 402a), “was with” (labeled as keyword 402b), “not” (labeled as keyword 402c) and “happy” (labeled as keyword 402d).

In another embodiment, the sentence analyzing module 104 analyzes the input terms of the input sentence by referring to the ontology components of the emotion ontology 300 and determines at least one keyword of the input sentence according to the input terms and the ontology components of the emotion ontology 300. For instance, the sentence analyzing module 104 analyzes the input sentence 402 to obtain the input terms, and then compares the concepts of the input terms with the ontology components 302 of the ontology. When the concept of the input term is as same as or similar to the concept of one of the ontology components, the input term is regarded as the keyword of the input sentence. Furthermore, the sentence analyzing module 104 can further refers to the synonym data or/and the antonym data to determine the keywords of the input sentence. For instance, the sentence analyzing module 104 determines whether the input term and the ontology component 302 have the same or similar concepts by referring to the synonyms or antonyms of the input terms in the input sentence 402 and further determines whether the input term is the keyword.

FIG. 5 is a schematic view showing the step of analyzing a similarity level between the input sentence and the case sentences according to one embodiment of the present invention. As shown in FIG. 5, in the present embodiment, the similarity analyzing module 106 performs a syntax analysis and a semantic analysis on both of the input sentence 402 (“Today, when I was with Baby, I felt Baby was not very happy.”) and the case sentence 122a (“Today is a dating day.”). The syntax analysis is to analyze a sentence structure similarity level between the parse tree 404 of the input sentence 402 and the case sentence 122a. For instance, the sentence structure similarity level can be determined according to the number of the editorial steps for re-editing the input sentence to be at least one of the case sentences. In other input terms, in the step for comparing the structure of the parse tree 404 with the structure of the case sentence 122a, the input sentence 402 is re-edited to be the case sentence 122a by the editorial steps including inserting input terms, deleting input terms and modifying the use of the input terms. Also, the number of the editorial steps is denoted N. Similarly, in the step for comparing the structure of the parse tree 404 with the structure of another case sentence, the input sentence 402 is re-edited to be another case sentence by the aforementioned editorial steps with the number of the editorial steps denoted M. When N is smaller than M, the editorial steps for re-editing the input sentence 402 to be the case sentence 122a is less than the editorial steps for re-editing the input sentence 402 to be another case sentence. That is, the syntax of the input sentence 402 is more similar to the case sentence 122a. Hence, the sentence structure similarity level between the input sentence 402 and the case sentence 122a is relatively high.

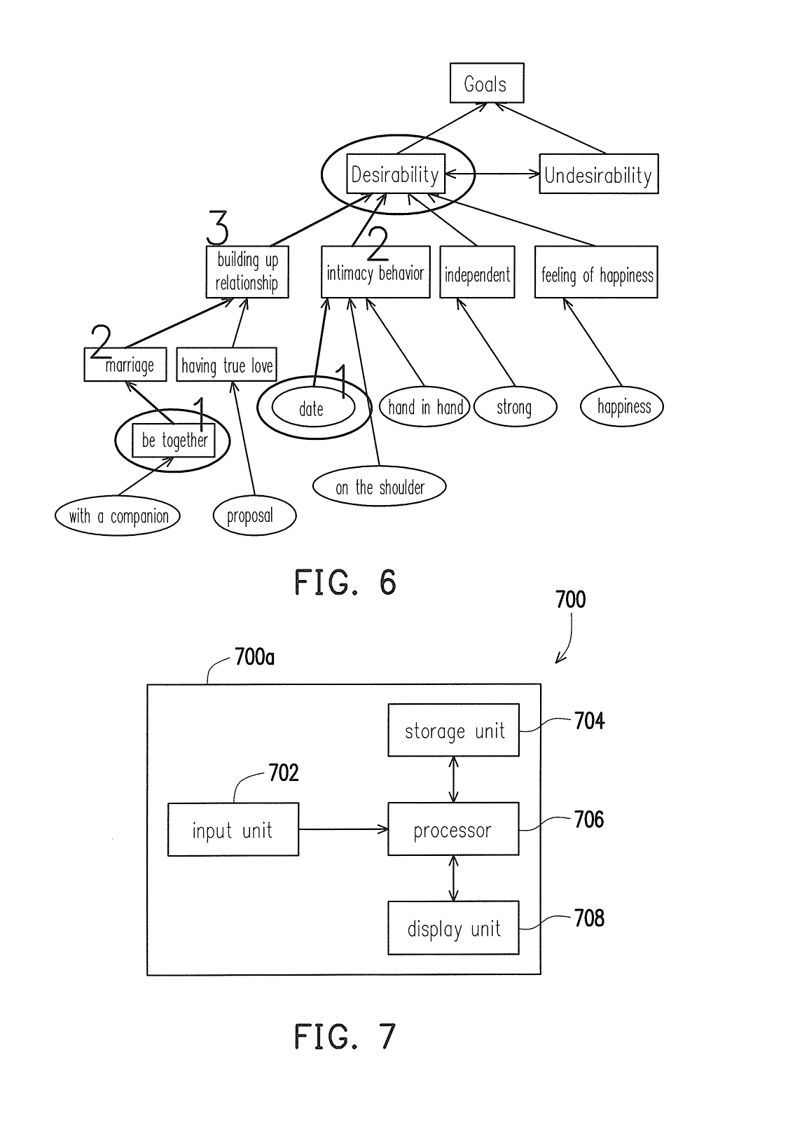

In another embodiment, the semantic analysis is to analyze a semantic level between each of the keywords in the input sentence 402 and the major terms of each of the case sentences according to the emotion ontology 300. FIG. 6 is a schematic view showing the step of analyzing a semantic level between the input sentence and the case sentences according to one embodiment of the present invention. As shown in FIG. 6, the semantic analysis for analyzing the semantic level between the input sentence 402 (“Today, when I was with Baby, I felt Baby was not very happy.”) and the case sentence 122a (“Today is a dating day.”) in the case repository 120 is taken as an example. In the present embodiment, the semantic level between the input sentence 402 and the case sentence 122a is determined by calculating a hierarchical distance, in the emotion ontology 300, between the ontology components 302 corresponding to the keywords in the input sentence 402 and the ontology components 302 corresponding to the major terms of the case sentence 122a, and the aforementioned major terms are with respect to the keywords in the input sentence 402 respectively.

The hierarchical distance between the ontology components, which are with respect to the keywords of the input sentence and to the major terms of the case sentences respectively corresponding to the keywords, can be calculated based on various concepts. For instance, the keyword 402b denoting “was with” in the input sentence 402 is corresponding to the major term “dating” in the case sentence 122a. Hence, in the emotion ontology 300, the hierarchical distance between the ontology component 302 with respect to the keyword 402b and the ontology component 302 with respect to the major term “dating” is three. That is, the hierarchical distance can be the maximum value among the distances respectively from the ontology components 302, respectively corresponding to the keyword and the major terms related to the keyword, to the common parent node of the ontology components 302 in the emotion ontology 300. In other words, in the emotion ontology, when the ontology components, respectively corresponding to the keyword and the related term, are closer to the common parent node, the meaning of the keyword is closer to the meaning of the related major term and the semantic level between the keyword and the related term is large. In another hierarchical distance calculation concept, the semantic level between the keywords in the input sentence 402 and the major terms of the case sentences 122 can be determined according to the hierarchy level of the common parent node of the ontology components 302 respectively with respect to the keyword and the related major term. That is, when the hierarchy level of the common parent node of the ontology components 302 respectively with respect to the keyword and the related major term is closer to the root node of the emotion ontology 300, the meaning of the keyword is more different from the meaning of the related term and the semantic level between the keyword and the related term is smaller.

Moreover, in one embodiment, according to the experiences and the practical requirements, the similarity analyzing module 106 can assign different weighted values to the sentence structure similarity level and the semantic level respectively to accurately calculate the similarity level between the input sentence 402 and each of the case sentences. In another embodiment, the weighted value of the semantic level can be larger than the weighted value of the sentence structure similarity level.

Moreover, the emotion detection module 108 further sorts the case sentences according to the similarity levels between the input sentence and the case sentences. Thus, the case sentence with a relatively higher similarity level to the input sentence is promoted to a higher priority. And, according to the customized selecting factors, at least the emotion annotation of the case sentence with the first priority in the sorted case sentences is selected to be the emotion expressed by the input sentence. That is, the emotion annotation of the case sentence with the highest similarity level to the input sentence is selected to be the emotion expressed by the input sentence.

In the aforementioned embodiment, the emotion analyzing method of the invention may be implemented by executing a computer readable and writable program and the emotion analyzing system may also be implemented as a computer readable and writable program. This computer readable and writable program and the aforementioned case repository may be stored in a computer readable and writable recording medium and may execute several commands to embody the emotion analyzing method of the invention. The executed steps of the emotion analyzing method are clearly described in the aforementioned embodiments, and thus no further description is provided herein.

Furthermore, the present invention also provides an emotion analyzing device for analyzing a received input sentence. FIG. 7 is a schematic view of an emotion analyzing device according to one embodiment of the invention. As shown in FIG. 7, the emotion analyzing device 700 comprises a housing 700a, an input unit 702 configured at the exterior of the housing 700a, a storage unit 704 and a processor 706 configured in the interior of the housing 700a and a display unit 708 configured at the housing 700a.

The storage unit 704 is used for storing a case repository, wherein the case repository includes a plurality of case sentences, and each of the case sentences includes at least a major term and each of the case sentences corresponds to at least an emotion annotation. The storage unit 704 further stores an emotion analyzing program. The processor 706 is connected to the input unit 702 and the storage unit 704. The processor 706 executes the emotion analyzing program to analyze a sentence structure of the input sentence, and to perform a semantic analysis and a syntax analysis on the input sentence and on at least one case sentence in the case repository, according to the sentence structure, so as to obtain a similarity level between the input sentence and at least one case sentence, and to detect at least one emotion of the input sentence. The emotion analyzing program executed by the processor 706 comprises analyzing the sentence structure of the input sentence, performing the syntax analysis and the semantic analysis on the input sentence and at least one case sentence, detecting at least one emotion of the input sentence, which are detailed in the aforementioned embodiments related to the emotion analyzing method and the emotion analyzing system and are not repeated herein.

Further, the aforementioned input unit 702 can be, for example, a keyboard or a touch screen, and the display unit 708 can be, for example, a display or a touch screen. That is, the input unit 702 can be integrated with the display to be a touch screen capable of displaying and receiving the input sentence. Moreover, the display unit 708 can be, for example, a display, an audio output device, a light displaying device, an LED display or a portable device. Also, the emotion feedback can be, for example, an emotion symbol, an emotional expression image, a text, an audio effect, a light effect or a mechanical operation. In the embodiment shown in FIG. 1, the output module 110 of the emotion analyzing system 100 can be connected to, for example, a display, an audio output device, a light displaying device, an LED display or an electronic pet for practically showing the aforementioned emotion feedbacks.

Also, the emotion analyzing device 700 can be, for example, a multimedia game console, a handheld game console, a robot, an electronic pet, a personal computer, a portable computer, a portable communication device or a personal digital assistant.

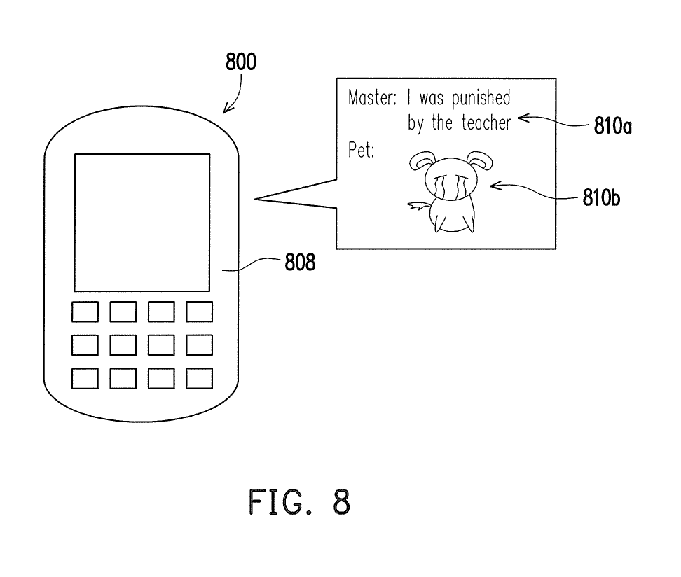

In one embodiment of the present invention, the emotion analyzing device 700 can be a portable handheld game console, such as a pet game console (the pet game console 800 shown in FIG. 8). By detecting the emotion of the input sentence inputted by the user, the pet game console 800 can response the user an emotion feedback in form of a virtual animation image (the emotion response 810b displayed on the display unit 808 shown in FIG. 8) to reflect the emotion of the input sentence. The aforementioned input unit is used for receiving an input sentence, and the display unit is used for displaying the generated emotion feedback after the emotion of the input sentence is detected.

Accordingly, in the present invention, by using the case sentences in the case repository and the emotion ontology, the syntax analysis and the semantic analysis are performed on the input sentence so as to obtain the similarity level between the input sentence and each of the case sentences. According to the similarity level, the sentence emotion of the input sentence can be detected. By using the concept-relation-instance feature of the emotion ontology, the accuracy of deducing the sentence emotion of single input sentence is increased, and the various emotions of various input sentences can also be detected. Further, not only the explicit emotion in the sentence can be detected but also the implied emotion in the sentence can be detected. Also, in the emotion analyzing system of the present invention, the instance of the emotion ontology can be expanded by adding new case sentences therein. Even, the case repository can be trained by only annotating the newly added case sentences with the emotion annotations and determining the major terms of the newly added case sentences. Thus, it is not necessary to re-build the emotion ontology.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An emotion analyzing system, comprising:
a case repository including a plurality of case sentences, wherein each of the case sentences includes at least a major term and each of the case sentences corresponds to at least an emotion annotation;
an input module for receiving an input sentence;
a sentence analyzing module for analyzing a sentence structure of the input sentence;
a similarity analyzing module for performing a semantic analysis and a syntax analysis on the input sentence and on the at least a case sentence in the case repository, according to the sentence structure, so as to obtain a similarity level between the input sentence and the at least a case sentence; and
an emotion detection module for detecting at least an emotion of the input sentence according to the similarity level between the input sentence and the at least a case sentence.

2. The emotion analyzing system of claim 1, wherein the sentence analyzing module analyzing the sentence structure of the input sentence comprises analyzing a plurality of input terms of the input sentence and annotating each of the input terms a lexical category, and, according to the lexical category each of the input terms belongs to, at least a keyword in the input sentence is determined.

3. The emotion analyzing system of claim 1 further comprising an emotion ontology having a plurality of ontology components; and wherein the sentence analyzing module analyzing the sentence structure of the input sentence comprises analyzing a plurality of input terms of the input sentence, and, according to the input terms and the ontology components of the emotion ontology, at least a keyword in the input sentence is determined.

4. The emotion analyzing system of claim 1 further comprising a synonym data, an antonym data and an emotion ontology having a plurality of ontology components, wherein the sentence analyzing module analyzing a plurality of input terms of the input sentence, and, according to the input terms of the input sentence, the ontology components of the emotion ontology, the synonym data and the antonym data, at least a keyword in the input sentence is determined.

5. The emotion analyzing system of claim 1 further comprising an emotion ontology having a plurality of ontology components, wherein the sentence analyzing module further determines at least a keyword of the input sentence; and the syntax analysis of the similarity analyzing module is used to analyze a sentence structure similarity level between the input sentence and the at least a case sentence, and the semantic analysis, according to the emotion ontology, is used to analyze a semantic level between each of the keywords in the input sentence and the major terms of the at least a case sentence; and, according to the sentence structure similarity level and the semantic level, the emotion detection module obtains the similarity level between the input sentence and the at least a case sentence.

6. The emotion analyzing system of claim 5, wherein the syntax analysis is to compare a parse tree of the input sentence with a structure of the at least a case sentence, and, according to number of editorial steps for re-editing the input sentence to be the at least a case sentence, the sentence structure similarity level is determined.

7. The emotion analyzing system of claim 5, wherein the semantic level is determined by calculating a hierarchical distance, in the emotion ontology, between the ontology components corresponding to the keywords in the input sentence and the ontology components corresponding to the major terms of the case sentence, and wherein the major terms are with respect to the keywords in the input sentence respectively.

8. The emotion analyzing system of claim 1 further comprising an output module outputting an emotion feedback with respect to the detected emotion of the input sentence.

9. An emotion analyzing device, comprising:
a housing;
an input unit configured at an exterior of the housing for receiving an input sentence;
a storage unit configured in an interior of the housing, the storage unit is used for storing a case repository including a plurality of case sentences, and each of the case sentences includes at least a major term and each of the case sentences corresponds to at least an emotion annotation;
a processor configured in the interior of the housing, wherein the processor is connected to the input unit and the storage unit and the processor is used for analyzing a sentence structure of the input sentence, and performing a semantic analysis and a syntax analysis on the input sentence and on at least a case sentence in the case repository, according to the sentence structure, so as to obtain a similarity level between the input sentence and the at least case sentence, and detecting at least an emotion of the input sentence; and
a display unit for displaying an emotion feedback corresponding to the detected emotion.

10. The emotion analyzing device of claim 9, wherein analysis of the sentence structure of the input sentence performed by the processor further comprises:
analyzing a plurality of input terms in the input sentence and annotating each of the input terms a lexical category; and
determining at least a keyword of the input sentence according to the lexical category of each of the input terms.

11. The emotion analyzing device of claim 9, wherein the storage unit further stores an emotion ontology having a plurality of ontology components; and the analysis of the sentence structure of the input sentence performed by the processor is to analyze a plurality of input terms of the input sentence, and, according to the input terms and the ontology components of the emotion ontology, at least a keyword in the input sentence is determined.

12. The emotion analyzing device of claim 9, wherein the storage unit further stores a synonym data, an antonym data, and an emotion ontology having a plurality of ontology components; and the processor further analyzes a plurality of input terms of the input sentence, and, according to the input terms of the input sentence, the ontology components of the emotion ontology, the synonym data and the antonym data, at least a keyword in the input sentence is determined.

13. The emotion analyzing device of claim 9, wherein the storage unit further stores an emotion ontology having a plurality of ontology components; the processor further determines at least a keyword of the input sentence; and the processor performs the syntax analysis on the input sentence and on the at least a case sentence of the case repository for analyzing a sentence structure similarity level between the input sentence and the at least a case sentence, and the processor performs the semantic analysis, according to the emotion ontology, for analyzing a semantic level between each of the keywords in the input sentence and the major terms of the at least a case sentence; and, according to the sentence structure similarity level and the semantic level, the processor obtains the similarity level between the input sentence and the at least a case sentence so as to detect the at least an emotion of the input sentence.

14. The emotion analyzing device of claim 13, wherein the syntax analysis is to compare a parse tree of the input sentence with a structure of the at least a case sentence, and, according to number of editorial steps for re-editing the input sentence to be the at least a case sentence, the sentence structure similarity level is determined.

15. The emotion analyzing device of claim 13, wherein the semantic level is determined by calculating a hierarchical distance, in the emotion ontology, between the ontology components corresponding to the keywords in the input sentence and the ontology components corresponding to the major terms of the case sentence, and wherein the major terms are with respect to the keywords in the input sentence respectively.

16. An emotion analyzing method implemented with a case repository, wherein the case repository includes a plurality of case sentences, and each of the case sentences includes at least a major term and each of the case sentences corresponds to at least an emotion annotation, the emotion analyzing method comprising:
receiving an input sentence;
analyzing a sentence structure of the input sentence;
performing a similarity analyzing process to simultaneously implement a semantic analysis and a syntax analysis on the input sentence and on at least a case sentence in the case repository, according to the sentence structure, so as to obtain a similarity level between the input sentence and the at least case sentence; and
detecting at least an emotion of the input sentence according to the similarity level between the input sentence and the at least case sentence.

17. The emotion analyzing method of claim 16, wherein the step of analyzing the sentence structure of the input sentence comprises analyzing a plurality of input terms of the input sentence and annotating each of the input terms a lexical category, and, according to the lexical category each of the input terms belongs to, determining at least a keyword in the input sentence.

18. The emotion analyzing method of claim 16 further comprising providing an emotion ontology, wherein the emotion ontology has a plurality of ontology components; and wherein the step of analyzing the sentence structure of the input sentence comprises analyzing a plurality of input terms of the input sentence, and, according to the input terms and the ontology components of the emotion ontology, determining at least a keyword in the input sentence.

19. The emotion analyzing method of claim 16, wherein the step of analyzing the sentence structure of the input sentence comprises providing a synonym data, an antonym data, and an emotion ontology having a plurality of ontology components, and analyzing a plurality of input terms of the input sentence, and, according to the input terms of the input sentence, the ontology components of the emotion ontology, the synonym data and the antonym data, determining at least a keyword in the input sentence.

20. The emotion analyzing method of claim 16, wherein the step of analyzing the sentence structure of the input sentence further comprises providing an emotion ontology having a plurality of ontology components; determining at least a keyword of the input sentence; the syntax analysis is to analyze a sentence structure similarity level between the input sentence and the at least a case sentence, and the semantic analysis, according to the emotion ontology, is to analyze a semantic level between each of the keywords in the input sentence and the major terms of the at least a case sentence; and, according to the sentence structure similarity level and the semantic level, the similarity level between the input sentence and the at least a case sentence is obtained.

21. The emotion analyzing method of claim 20, wherein the syntax analysis is to compare a parse tree of the input sentence with a structure of the at least a case sentence, and, according to number of editorial steps for re-editing the input sentence to be the at least a case sentence, the sentence structure similarity level is determined.

22. The emotion analyzing method of claim 20, wherein the semantic level is determined by calculating a hierarchical distance, in the emotion ontology, between the ontology components corresponding to the keywords in the input sentence and the ontology components corresponding to the major terms of the case sentence, and wherein the major terms are with respect to the keywords in the input sentence respectively.

23. The emotion analyzing method of claim 16 further comprising outputting an emotion feedback with respect to the detected emotion of the input sentence.

24. A computer readable and writable recording medium for storing an emotion analyzing program and a case repository, wherein the case repository includes a plurality of case sentences, and each of the case sentences includes at least a major term and each of the case sentences corresponds to at least an emotion annotation, and the emotion analyzing program executes a plurality of commands, and the commands comprising:
receiving an input sentence;
analyzing a sentence structure of the input sentence;
performing a similarity analyzing process to simultaneously implement a semantic analysis and a syntax analysis on the input sentence and on at least a case sentence in the case repository, according to the sentence structure, so as to obtain a similarity level between the input sentence and the at least case sentence; and
detecting at least an emotion of the input sentence according to the similarity level between the input sentence and the at least case sentence.
